(19) United States
(12) Patent Application Publication
(10) Pub. No.: US 2010/0245837 A1
(43) Pub. Date: Sep. 30, 2010

(54) POLARIZATION INTERFEROMETER, OPTICAL MODULE, AND OPTICAL RECEIVER

(75) Inventor: Tsuyoshi YAMAMOTO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/724,551

(22) Filed: Mar. 16, 2010

(30) Foreign Application Priority Data
Mar. 30, 2009 (JP) 2009-083010

(51) Int. Cl. G01B 9/02

(52) U.S. Cl. 356/491

(57) ABSTRACT

A interferometer includes a first splitter for splitting one of a signal and a reference lights into a first and a second branch lights; a second splitter for splitting the other of a signal and a reference lights into a third and a fourth branch lights; a first coupler for causing the first and the third branch lights to interfere with each other, and outputting a first detection light; a second coupler for causing the second and the fourth branch light to interfere with each other, and outputting a second detection light; a first polarization phase controller provided between the first beam splitter and the first coupler, and outputting the phase-controlled polarization components of the first branch light; and a second polarization phase controller provided between the second beam splitter and the second coupler, and outputting the phase-controlled polarization components of the fourth branch light.

### CROSS-REFERENCE TO RELATED APPLICATION

This application is based upon and claims the benefit of priority of the prior Japanese Patent Application No. 2009-083010, filed on Mar. 30, 2009, the entire contents of which are incorporated herein by reference.

### FIELD

The present application relates to a polarization interferometer, an optical module, and an optical receiver.

### BACKGROUND

In optical networks (e.g. ultra high speed photonic networks) for long-distance transmission, the market has been paying attention to phase modulation such as (differential) quadrature phase-shift keying ((D)QPSK) as the transmission speed has been increasing. In order to increase the transmission capacity, development of methods of using polarization division multiplexing together with wavelength division multiplexing is also underway.

A phase-modulate signal light such as that encoded in QPSK can be demodulated using, for example, homodyne detection that causes a signal light and each of reference lights (local lights) having the same wavelength as that of the signal light to cause interference with each other. That is, reference lights, one having a phase of 0 degree and the other having a phase of 90 degrees, and a signal light are caused interference with each other, thereby detecting in-phase channel (I-ch) and quadrature-phase channel (Q-ch) modulated signals. A device that performs this process is a 90-degree hybrid (interferometer). The I-ch and Q-ch modulated signal lights detected by using the 90-degree hybrid are received by using, for example, balanced receivers and are demodulated to four values through, for example, digital signal processing.

A 90-degree hybrid has the function of mixing a signal light and a reference light and causing the signal light and the reference light to interfere with each other, and the function of adding a 90-degree phase (¼ wavelength) to the reference light. By adjusting the phase of the signal light to match the phase of the reference light, which are to be mixed with each other, the quality of demodulated signals can be improved.

In demodulation of a polarization multiplexed phase-modulated signal, the signal light is separated by polarization beam splitter into individual polarization light. After separation to each polarized signal light, each signal light is demodulated by front-end modules.

A front-end module is an integrated module including, for example, the above-described 90-degree hybrid and the balanced receivers. When two front-end modules are used, the dimensions of a device are accordingly increased.

Related-art techniques are disclosed in US Patent Application Nos. 2008/0152361, 2008/0152362, and 2008/0152363.

To reduce the increased dimensions of a device, sharing same 90 degree hybrid at two polarization signal light is proposed. In this case, polarization dependence in the 90-degree hybrid may cause a phase shift between a signal light and a reference light.

The polarization dependence which may occur in this case includes polarization dependence of phase delay that occurs owing to a birefringent material on an optical path or an optical film in the case where the 90-degree hybrid is shared by the two polarizations, and polarization dependence of an element that adds the 90-degree phase.

### SUMMARY

According to an aspect of the invention, a interferometer for receiving a signal light and a reference light and for outputting phase detection signal lights, includes a first beam splitter for splitting one of the signal and the reference lights into a first and a second branch lights; a second beam splitter for splitting the other of the signal and the reference lights into a third and a fourth branch lights; a first coupler for causing the first and the third branch lights to interfere with each other, and outputting a first phase detection signal light; a second coupler for causing the second and the fourth branch light to interfere, with each other, and outputting a second phase detection signal light; an optical phase shifter for shifting the optical phase by an amount between the third and the fourth branch lights inputted into the first or second coupler; a first polarization phase controller provided between the first beam splitter and the first coupler, the first polarization phase controller individually controlling phases of two orthogonal polarization components of the first branch light and outputting the phase-controlled polarization components of the first branch light; and a second polarization phase controller provided between the second beam splitter and the second coupler, the second polarization phase controller individually controlling phases of two orthogonal polarization components of the fourth branch light and outputting the phase-controlled polarization components of the fourth branch light.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a first embodiment;

FIG. 2 is a diagram illustrating optical communication system;

FIG. 3 is a table describing an example of a control mode of wave plates by using a temperature controller;

FIG. 4 includes diagrams describing an example in which the phase shift in increments of a polarization component between a signal light and a reference light is compensated for;

FIG. 5 is a diagram illustrating a first modification of the first embodiment;

FIG. 6 is a diagram illustrating a second modification of the first embodiment;

FIG. 7 is a diagram illustrating a second embodiment; and

FIG. 8 is a diagram illustrating a third embodiment.

### DESCRIPTION OF EMBODIMENTS

Referring now to the drawings, embodiments will be described. The embodiments described below are for illustrative purposes only, and it is not intended to exclude various modification and technical applications that are not disclosed below. In short, various modifications can be added to the embodiments without departing from the scope thereof.

### [A] Description of First Embodiment

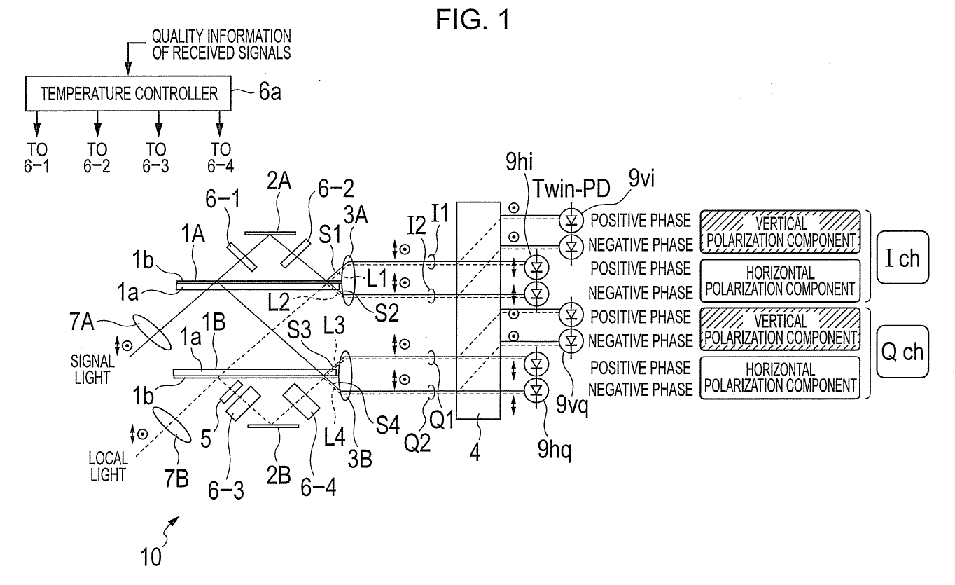

FIG. 1 is a diagram illustrating a first embodiment. In FIG. 1, a 90-degree hybrid 10 and balanced receivers 9vi, 9vq, 9hi, and 9hq are illustrated. The 90-degree hybrid 10 and the balanced receivers 9vi, 9vq, 9hi, and 9hq (hereinafter may also be collectively referred to as “balanced receivers 9”) may be integrated into a single optical module.

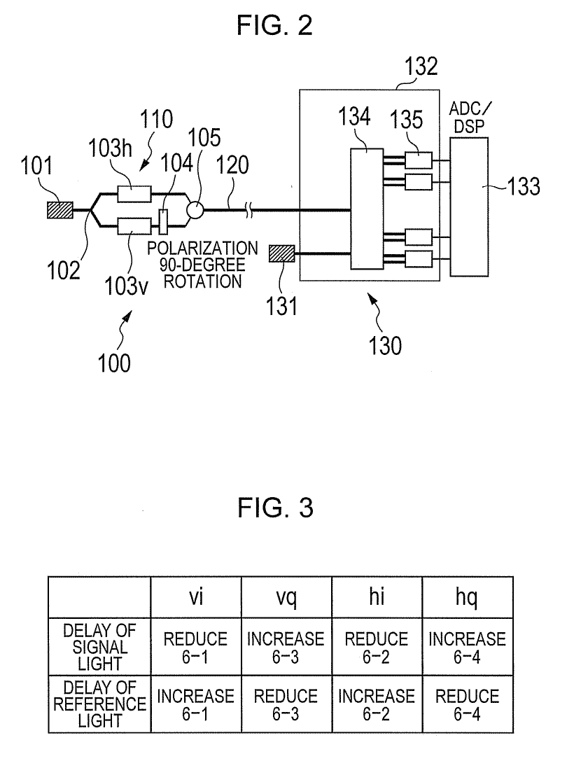

The integrated optical module may be referred to as an “optical front-end”. The 90-degree hybrid 10 and the balanced receivers 9 illustrated in FIG. 1 are applicable as elements of an optical receiver in an optical communication system illustrated in FIG. 2.

In an optical communication system 100 illustrated in FIG. 2, an optical transmitter 110 is coupled to an optical receiver 130 via an optical transmission line 120. The optical transmitter 110 includes, for example, a laser diode (LD) 101 serving as a light source, a splitter 102, modulators 103h and 103v, a polarization rotator 104, and a polarization beam combiner (PBC) 105.

That is, signal lights individually modulated by the modulators 103h and 103v using light emitted from the LD 101 are polarization-division-multiplexed by the PBC 105. At this time, one optical signal (signal light coming from the modulator 103v) is polarization-rotated by 90 degrees, and the PBC 105 can output a polarization-division-multiplexed signal light.

The optical receiver 130 includes a local laser diode (LD) 131 serving as a light source, an optical front-end 132, and an electrical signal processor (analog-to-digital converter/digital signal processor (ADC/DSP)) 133. The optical front-end 132 includes an optical hybrid 134 and four balanced receivers 135.

The 90-degree hybrid 10 illustrated in FIG. 1 can be used as the optical hybrid 134. As lights to be interfered with a local light, the optical hybrid 134 outputs an I signal and a Q signal of each polarization component. The balanced receivers 9 illustrated in FIG. 1 can be used as the four balanced receivers 135. The balanced receivers 135 detect modulated signals of the I signal and the Q signal of each polarization. The electrical signal processor 133 performs signal demodulation processing by using the signals from the balanced receivers 135.

The 90-degree hybrid 10 illustrated in FIG. 1 has a function that mixes polarization multiplexed signal light (from the optical transmitter 110—see FIG. 2—) and reference light (from the local LD 131 as a local light) collectively, instead of each polarization light individually. By using linearly-polarized lights whose polarization directions are tilted by, for example, 45 degrees with respect to the polarization directions of two orthogonal signal lights, respectively, as reference lights from the local LD 131, vertically and horizontally polarized reference lights can be obtained.

The 90-degree hybrid 10 illustrated in FIG. 1 includes two beam splitters 1A and 1B having equivalent characteristics, mirrors 2A and 2B, condensers 3A and 3B, a birefringent plate 4, a 90-degree-phase shifter 5, wave plates 6-1 to 6-4, and a temperature controller 6a.

The beam splitters 1A and 1B illustrated in FIG. 1 are arranged facing each other so that their base members is face inward and their beam splitter films 1b face outward. The beam splitters 1A and 1B can be arranged in parallel to each other. A signal light and a reference light enter the beam splitters 1A and 1B from diagonal directions with respect to the member planes of the beam splitters 1A and 1B.

In this example, a signal light enters the base member 1a side of the beam splitter 1A, and a reference light enters the beam splitter film 1b side of the beam splitter 1B. At this time, the entering signal light and its reflected light can be parallel and can be caused to enter the corresponding beam splitters 1A and 1B at an equivalent angle. A lens 7A directs a signal light from an optical transmission line 111 to the beam splitter 1A. A lens 7B directs a reference light from the local LD 131 to the beam splitter 1B.

A signal light that enters the beam splitter 1A passes through the base member 1a and partially enters the beam splitter 1B through the beam splitter film 1b. The remaining signal light is reflected from the beam splitter film 1b. Therefore, the beam splitter 1A is an example of a signal light splitter that splits a signal light into a first signal light and a second signal light.

A local light that enters the beam splitter 1B partially passes through the beam splitter film 1b and the base member 1a and enters the base member 1a of the beam splitter 1A. The remaining reference light is reflected from the beam splitter film 1b. Therefore, the beam splitter 1B is an example of a local light splitter that splits a local light into a first local light and a second local light.

The mirror 2A reflects a signal light that has passed through the beam splitter 1A (first signal light) so that the first signal light will re-enter the beam splitter film 1b of the beam splitter 1A. Also, the wave plates 6-1 and 6-2 described later are provided on an optical path that the first signal light that has passed through the beam splitter 1A re-enters. In other words, the first signal light that has passed through the beam splitter 1A as described above re-enters the beam splitter 1A through the above-described wave plates 6-1 and 6-2 and the mirror 2A.

The mirror 2B reflects a local light that has been reflected from the beam splitter 1B (second local light). The optical path of the second local light reflected from the mirror 2B is folded so that the second local light re-enters the beam splitter film 1b of the beam splitter 1B. Also, the 90-degree-phase shifter 5 and the wave plates 6-3 and 6-4 described later are provided on an optical path in which the light reflected from the beam splitter 1B re-enters the beam splitter 1B. In other words, the second local light reflected from the beam splitter 1B re-enters the beam splitter 1B through the above-described 90-degree-phase shifter 5, the wave plates 6-3 and 6-4, and the mirror 2B.

Furthermore, the first signal light that re-enters the beam splitter 1A is split into a light of a component re-reflected from the beam splitter film 1b (see S1 in FIG. 1) and a light of a component that passes through the beam splitter film 1b and the base member 1a (see S2 in FIG. 1).

In contrast, the first local light that has passed through the beam splitter 1B passes through the base member 1a of the beam splitter 1A and enters the beam splitter film 1b. The first local light entering the beam splitter film 1b partially passes through the beam splitter film 1b (see L1 in FIG. 1). The remaining first local light is reflected from the beam splitter film 1b (see L2 in FIG. 1).

At this time, the first signal light and the first local light that are incident on the beam splitter 1A enter the beam splitter 1A from the opposite sides. By setting the positions and angles at which the first signal light and the first local light enter the beam splitter 1A, lights split from the signal light and the local light can be grouped in two pairs of lights that travel along the same optical axis and that are mixed. That is, the signal light S1 and the local light L1 which are obtained by the splitting and which travel along the same optical axis can be mixed, and the signal light S2 and the local light L2 which are obtained by the splitting and which travel along the same optical axis can be mixed.

In contrast, the second signal light reflected from the beam splitter 1A passes through the beam splitter 1A and enters the beam splitter 1B. That is, the second signal light passes through the base member 1a of the beam splitter 1B and enters the beam splitter film 1b. The second signal light entering the beam splitter film 1b of the beam splitter 1B is partially reflected from the beam splitter film 1b (see S3 in FIG. 1). The remaining second signal light passes through the beam splitter film 1b (see S4 in FIG. 1).

Furthermore, the second local light that is reflected from the mirror 2B and that re-enters the beam splitter 1B is split into a light that passes through the beam splitter film 1b and the base member is (see L3 in FIG. 1) and a light that is re-reflected from the beam splitter film 1b (see L4 in FIG. 1).

At this time, the second signal light and the second local light that are incident on the beam splitter 1B enter the beam splitter 1B from the opposite sides. By setting the positions and angles at which the second signal light and the second local light enter the beam splitter 1B, lights split from the signal light and the local light can be grouped in two pairs of lights that travel along the same optical axis and that are mixed. That is, the signal light S3 and the local light L3 which are obtained by the splitting and which travel along the same optical axis can be mixed, and the signal light S4 and the local light L4 which are obtained by the splitting and which ravel along the same optical axis can be mixed.

The 90-degree-phase shifter 5 adds a 90-degree phase shift to one of two local lights that are split from a local light directed from the lens 7B, that is, a local light reflected from the mirror 2B in this example. Therefore, the local lights L3 and L4 are given a 90-degree phase difference with respect to the local lights L1 and L2. Thus, the 90-degree-phase shifter 5 is an example of an optical phase shifter that optically shifts the phase by an amount given to a first or second reference light input to a first or second coupler.

That is, a local light to be mixed with a signal light in the beam splitter 1A is not given a phase shift by the 90-degree-phase shifter 5. In contrast, a local light to be mixed with a signal light in the beam splitter 1B is given a phase shift by the 90-degree-phase shifter 5.

Therefore, pairs of a signal light and a local light (S1 and L1, and S2 and L2), which are mixed lights obtained by mixing in the beam splitter 1A, can be first detection lights I1 and I2 of in-phase channel (I-ch). Pairs of a signal light and a local light (S3 and L3, and S4 and L4), which are mixed lights obtained by mixing in the beam splitter 1B, can be second detection lights Q1 and Q2 of quadrature-phase channel (Q-ch).

In other words, the beam splitter 1A is an example of a first coupler that causes a first signal light and a first local light to interfere with each other and outputs a first detection light. The beam splitter 1B is an example of a second coupler that causes a second signal light and a second local light to interfere with each other and outputs a second detection light.

The condenser 3A individually condenses the detection lights I1 and I2 from the above-described beam splitter 1A. The condenser 3B individually condenses the detection lights Q1 and Q2 from the above-described beam splitter 1B. Therefore, the condensers 3A and 3B are examples of a collimator that individually collimates the detection lights outputted by the first and second couplers 1A and 1B. The condensers 3A and 3B may be integrated with each other.

The birefringent plate 4 separates each of the above-described I-ch and Q-ch detection lights into two polarization components that are the elements of polarization-division multiplexing. That is, the birefringent plate 4 illustrated in FIG. 1 separates the polarizations of detection lights I1, I2, Q1, and Q2 outputted by collectively multiplexing two polarization components of a modulated signal light with a reference light. In other words, the birefringent plate 4 is an example of a polarization splitter that splits each of detection lights collimated by the condensers 3A and 3B into different polarizations.

Accordingly, the balanced receiver 9vi can perform balanced reception by receiving vertical polarization components of the detection lights I1 and I2, which are obtained by polarization separation performed by the birefringent plate 4. Similarly, the balanced receiver 9hi can perform balanced reception by receiving horizontal polarization components of the detection lights I1 and I2.

Also, the balanced receiver 9vq can perform balanced reception by receiving vertical polarization components of the detection lights Q1 and Q2. Furthermore, the balanced receiver 9hq can perform balanced reception by receiving horizontal polarization components of the detection lights Q1 and Q2.

That is, I-ch and Q-ch electrical signals obtained by performing balanced reception by using the balanced receivers 9vi and 9vq are detection signals (vertical polarization components) obtained from a modulated signal. Also, I-ch and Q-ch electrical signals obtained by performing balanced reception by using the balanced receivers 9hi and 9hq are detection signals (horizontal polarization components) obtained from a modulated signal.

The above-described four balanced receivers 9 are associated with the four balanced receivers 135 illustrated in FIG. 2. That is, signals received by the balanced receivers 9 and converted into electrical signals and are output to the electrical signal processor 133. The electrical signal processor 133 performs signal demodulation processing based on the electrical signals from the balanced receivers 9.

The two wave plates 6-1 and 6-2 disposed in tandem on an optical path between the outer side of the beam splitter 1A and the mirror 2A change the amount of phase delay of each polarization signal light. The two wave plates 6-3 and 6-4 disposed in tandem on an optical path between the outer side of the beam splitter 1B and the mirror 2B change the amount of phase delay of each polarization local light.

The wave plates 6-1 and 6-3 are disposed so that their fast axes become horizontal with respect to a face formed by beams. The wave plates 6-2 and 6-4 are disposed so that their fast axes become vertical with respect to a face formed by beams.

That is, the wave plates 6-1 and 6-2 disposed in tandem on an optical path for a signal light each have the fast axis and the slow axis that face each other. Wave plates are configured to have the same optical thickness when at the same predetermined temperature. Thus, the phase shift in vertical polarization and the phase shift in horizontal polarization in the wave plates 6-1 and 6-2 cancel each other out, and no polarization dependence occurs.

Similarly, the wave plates 6-3 and 6-4 disposed in tandem on an optical path for a local light each have the fast axis and the slow axis that face each other. Wave plates are configured to have the same optical thickness when at the same predetermined temperature. Thus, the phase shift in vertical polarization and the phase shift in horizontal polarization in the wave plates 6-3 and 6-4 cancel each other out, and no polarization dependence occurs.

In the 90-degree hybrid 10 illustrated in FIG. 1, because the number of times a signal or local light passes through the base member is of the beam splitter 1A or 1B varies depending on the path of the signal or local light, a phase difference may occur on a path-by-path basis. Therefore, at the above-described predetermined temperature, the total optical thickness of the wave plates 6-1 and 6-2 and the total optical thickness of the wave plates 6-3 and 6-4 are given a difference that suppresses the above-described phase difference on a path-by-path basis.

In other words, phase differences between a signal light and a local light, which occur owing to the above-described differences in the number of times a light passes through the base member 1a, can be made equal by using the difference in the amount of delay (optical thickness) between the wave plates 6-1 and 6-2 and the wave plates 6-3 and 6-4 at the above-described predetermined temperature. That is, since a signal light enters the beam splitter 1A from the base member is side whereas a local light enters the beam splitter 1B from the beam splitter film 1b side instead of the base member is side, the phase difference can be absorbed by increasing the thickness of the wave plates 6-3 and 6-4.

It is assumed that x denotes the amount of delay when a signal or local light passes through the base member 1a; bt denotes a phase difference (amount of delay) when a signal or local light passes through (is transmitted through) the beam splitter film 1b; and br denotes a phase difference (amount of delay) when a signal or local light is reflected from the beam splitter film 1b. It is also assumed that the sum of the amounts of delay that occurs in the two wave plates 6-1 and 6-2 is 1m12, and the sum of the amounts of delay that occurs in the two wave plates 6-3 and 6-4 is 1m34.

In this case, the amount of delay of a signal light Si (i=integer from 1 to 4) is given by expression (S-i), and the amount of delay of a local light Li is given by expression (L-i). Therefore, the difference between the amounts of delay of a signal light and a local light that are grouped in a pair (e.g., Si-Li) is given by expression (D-i).

x+bt+lm12+br (S-1)

bt+x+x+bt (L-1)

lm12−x+br−bt (D-1)

x+bt+lm12+bt+x (S-2)

bt+x+x+br(+π)+x (L-2)

lm12−x+bt−br−π (D-2)

x+br(+π)+x+x+br(+π)+x (S-3)

br+lm34+bt+x (L-3)

3x−lm34+br−bt (D-3)

x+br(+π)+x+x+bt (S-4)

br+lm34+br (L-4)

3x−lm34+bt−br+π (D-4)

In expression (D-i), the term br−bt is a fixed value; the term br−bt may be a value sufficiently smaller than 1m12 and 1m34. In contrast, the term 1m12−x in expressions (D-1) and (D-2) is 0 when 1m12=x. Also, the term 1m34−x in expressions (D-3) and (D-4) is 0 when 1m34=3x.

In this manner, at the above-described predetermined temperature, the wave plates 6-1 and 6-2 through which a signal light is transmitted are configured to have an optical thickness that causes the total phase difference that occurs in the two wave plates 6-1 and 6-2 to be equivalent to the phase difference when a light is transmitted once through a plate included in the beam splitter 1A or 1B. Also, at the above-described predetermined temperature, the wave plates 6-3 and 6-4 are configured to have an optical thickness that causes the total phase difference that occurs in the two wave plates 6-3 and 6-4 to be equivalent to the phase difference when a light is transmitted three times through a plate included in the beam splitter 1A or 1B. Accordingly, the phase differences can be made equal in all paths.

Next, suppression of polarization dependence of the amount of delay on an optical path from the point at which a polarization-division-multiplexed signal light and a reference light enter the 90-degree hybrid 10 to the point at which the signal light and the reference light are multiplexed will be described. That is, polarization dependence of the amount of delay described above is suppressed by controlling the temperatures of the wave plates 6-1 to 6-4 by using the temperature controller 6a.

The temperature controller 6a individually controls the temperatures of the wave plates 6-1 to 6-4. That is, the temperature controller 6a individually controls the phases of two polarization components of a signal light that are orthogonal to each other by individually controlling the temperatures of the wave plates 6-1 and 6-2. Also, the temperature controller 6a individually controls the phases of two polarization components of a local light that are orthogonal to each other by individually controlling the temperatures of the wave plates 6-3 and 6-4.

For example, when the temperatures of the wave plates 6-1 and 6-3 whose fast axes are in the horizontal direction are increased from the predetermined temperature by using the temperature controller 6a, the phases of polarization components in the vertical direction can be delayed by using the wave plates 6-1 and 6-3. In contrast, when the temperatures of the wave plates 6-1 and 6-3 are reduced from the predetermined temperature, the phases of polarization components in the vertical direction can be delayed by using the wave plates 6-1 and 6-3.

FIG. 3 is a table describing an example of a control mode of the wave plates 6-1 to 6-4 by using the temperature controller 6a. For example, regarding the vertically polarized I-ch (see vi column in FIG. 3), when the phase of a signal light is delayed compared to the phase of a reference light, the temperature controller 6a reduces the temperature of the wave plate 6-1 to be lower than the predetermined temperature, thereby reducing the amount of delay in the phase of the signal light of the vertically polarized I-ch. In contrast, when the phase of a reference light is delayed compared to the phase of a signal light, the temperature controller 6a increases the temperature of the wave plate 6-1 to be higher than the predetermined temperature, thereby increasing the amount of delay in the phase of the signal light of the vertically polarized I-ch. Accordingly, the phase shift between the signal light and the reference light can be suppressed. Regarding the vertically polarized Q-ch (see vq column in FIG. 3), when the phase of a signal light is delayed compared to the phase of a reference light, the temperature controller 6a increases the temperature of the wave plate 6-3 to be higher than the predetermined temperature, thereby increasing the amount of delay in the phase of the reference light of the vertically polarized Q-ch. In contrast, when the phase of a reference light is delayed compared to the phase of a signal light, the temperature controller 6a reduces the temperature of the wave plate 6-3 to be lower than the predetermined temperature, thereby reducing the amount of delay in the phase of the reference light of the vertically polarized Q-ch. Accordingly, the phase shift between the signal light and the reference light can be suppressed.

Furthermore, regarding the horizontally polarized I-ch (see hi column in FIG. 3), when the phase of a signal light is delayed compared to the phase of a reference light, the temperature controller 6a reduces the temperature of the wave plate 6-2 to be lower than the predetermined temperature, thereby reducing the amount of delay in the phase of the signal light of the horizontally polarized I-ch. In contrast, when the phase of the reference light is delayed compared to the phase of the signal light, the temperature controller 6a increases the temperature of the wave plate 6-2 to be higher than the predetermined temperature, thereby increasing the amount of delay in the phase of the signal light of the horizontally polarized I-ch. Accordingly, the phase shift between the signal light and the reference light can be suppressed.

Regarding the horizontally polarized Q-ch (see hq column in FIG. 3), when the phase of a signal light is delayed compared to the phase of a reference light, the temperature controller 6a increases the temperature of the wave plate 6-4 to be higher than the predetermined temperature, thereby increasing the amount of delay in the phase of the reference light of the horizontally polarized Q-ch. In contrast, when the phase of the reference light is delayed compared to the phase of the signal light, the temperature controller 6a reduces the temperature of the wave plate 6-4 to be lower than the predetermined temperature, thereby reducing the amount of delay in the phase of the reference light of the horizontally polarized Q-ch. Accordingly, the phase shift between the signal light and the reference light can be suppressed.

Even when polarization multiplexed signal light is collectively mixed with a reference light, the phase delay of the signal light and the reference light can be controlled in independent of a polarization component as above. Therefore, polarization dependence of the amount of delay as described above can be suppressed by controlling the temperatures of the wave plates 6-1 to 6-4 by using the temperature controller 6a.

Thus, the cooperation of the wave plates 6-1 and 6-2 and the temperature controller 6a described above is an example of a first polarization phase controller that individually controls the phases of two polarization orthogonal components of a signal light, and outputs the phase-controlled polarization components, which is provided on a first optical path between the signal light splitter 1A and the first coupler 1A.

Also, the cooperation of the wave plates 6-3 and 6-4 and the temperature controller 6a described above is an example of a second polarization phase controller that individually controls the phases of two orthogonal polarization components of a reference light, and outputs the phase-controlled polarization components, which is provided on a second optical path between the reference light splitter 1B and the second coupler 1B.

Besides the above-described control example, the temperature controller 6a can suppress the phase shift between a signal light and a reference light by controlling, only in one direction (e.g., increasing), the temperatures of the wave plates 6-1 to 6-4 from the above-described predetermined temperature.

Also, the above-described temperature control of the wave plates 6-1 to 6-4 by using the temperature controller 6a can be performed on the basis of, for example, quality information of demodulated signals in increments of a polarization component, which is received by the temperature controller 6a from the electrical signal processor 133 illustrated in FIG. 2.

Specifically, from the received quality information, the temperature controller 6a derives the amount of phase shift between a vertically polarized I-ch component, which is one polarization-division-multiplexed component, of a signal light and a vertically polarized I-ch component of a reference light, and controls the temperatures of the wave plates 6-1 and 6-3 so as to compensate for the derived phase shift (in a direction in which the phase shift is suppressed). Similarly, from the received quality information, the temperature controller 6a derives the amount of phase shift between a horizontally polarized Q-ch component, which is one polarization-division-multiplexed component, of a signal light and a horizontally polarized component of a reference light, and controls the temperatures of the wave plates 6-2 and 6-4 so as to compensate for the derived phase shift (in a direction in which the phase shift is suppressed).

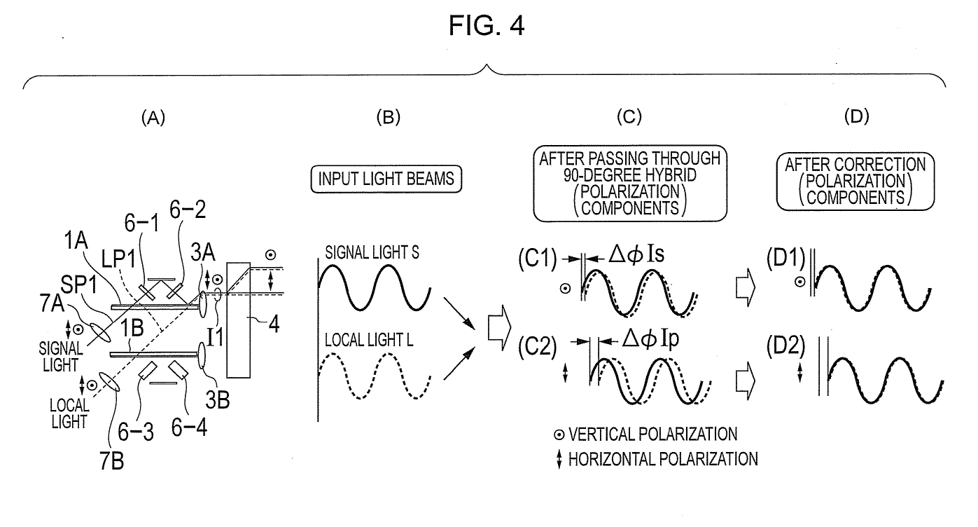

FIG. 4 includes diagrams describing an example in which the phase shift in increments of a polarization component between a signal light and a reference light is compensated for, by paying attention to vertically polarized components and horizontally polarized components of the first detection light I1. Part (A) of FIG. 4 illustrates an optical path SP1 of a signal light and an optical path LP1 of a local light of the first detection light I1.

As illustrated in part (B) of FIG. 4, it is assumed that a signal light S and a local light L input to the 90-degree hybrid 10 are in phase with each other. When the temperature controller 6a is not controlling the temperatures of the wave plates 6-1 to 6-4, as illustrated in part (C) of FIG. 4, a phase difference between the signal light S and the local light L may be different at each polarization component. This happens owing to the polarization dependence of the beam splitter films 1b in the 90-degree hybrid 10.

That is, as illustrated in part (Cl) of FIG. 4, a phase difference ΔφIs occurs between a vertically polarized component of the signal light S and a vertical polarization component of the local light L. A phase difference ΔφIp that is different from ΔφIs occurs between a horizontal polarization component of the signal light S and a horizontally polarized component of the local light L.

On the basis of quality information of demodulated signals, the temperature controller 6a derives the amount of phase shift between the signal light S and the local light L at each polarization component. The temperature controller 6a controls the temperatures of the wave plates 6-1 to 6-4 so as to compensate for the derived amount of phase shift.

For example, the electrical signal processor 133 provides quality information of demodulated signals obtained on the basis of signals output from the balanced receivers 9vi and 9vq to the temperature controller 6a. The temperature controller 6a controls the temperatures of the wave plates 6-1 and 6-2 in accordance with the amount of phase shift derived on the basis of the quality information from the electrical signal processor 133. Accordingly, as illustrated in part (D1) of FIG. 4, it is made possible to compensate for the phase difference between the vertical polarization component of the signal light S and the vertical polarization component of the local light L.

Similarly, the electrical signal processor 133 provides quality information of demodulated signals obtained on the basis of signals output from the balanced receivers 9hi and 9hq to the temperature controller 6a. The temperature controller 6a controls the temperatures of the wave plates 6-3 and 6-4 in accordance with the amount of phase shift derived on the basis of the quality information from the electrical signal processor 133. Accordingly, as illustrated in part (D2) of FIG. 4, it is made possible to compensate for the phase difference between the horizontal polarization component of the signal light S and the horizontal polarization component of the local light L.

According to the first embodiment as above, the 90-degree hybrid 10 can be achieved in which, even when detection is performed at a stage prior to separation of a light into optical signals in each polarization directions, a signal light and a reference light can be under optimal phase conditions at each polarization component, and the polarization dependence of phase delay is suppressed. Therefore, the 90-degree hybrid 10 can be commonly used in coherent optical reception of two polarization components of a polarization-division-multiplexed signal. Since no interaction occurs between different polarizations, even if a polarization-multiplexed signal light enters 90-degree hybrid 10, the result will be the same as the case where each polarization independently passes through the 90-degree hybrid 10.

Although it has been described that the structure of the 90-degree hybrid 10 includes the birefringent plate 4, which is an example of a polarization splitter, the structure of the 90-degree hybrid 10 may include a different module. Also, the 90-degree hybrid 10 may be integrated with the balanced receivers 9 into one module (reception front-end).

[A1] First Modification of First Embodiment

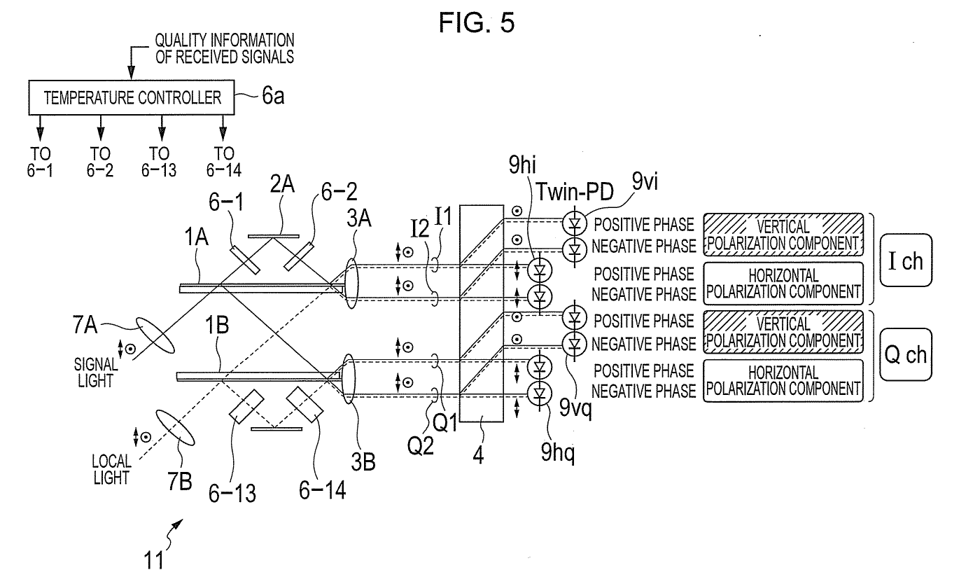

FIG. 5 is a diagram illustrating a first modification of the first embodiment. The first modification illustrated in FIG. 5 includes a 90-degree hybrid 11 that is different from the 90-degree hybrid 10 in the first embodiment, and the balanced receivers 9, which are the same as those in the first embodiment. In FIG. 5, the same reference numerals represent substantially the same portions as those in FIG. 1.

The 90-degree hybrid 11 and the balanced receivers 9 may be integrated into an optical module (optical front-end). Furthermore, the 90-degree hybrid 11 and the balanced receivers 9 illustrated in FIG. 5 are also applicable as elements of the optical receiver in the optical communication system illustrated in FIG. 2.

Unlike the 90-degree hybrid 10 in the first embodiment (see FIG. 1), the 90-degree hybrid 11 includes wave plates 6-13 and 6-14 functioning as the 90-degree-phase shifter 5. The wave plates 6-1 and 6-2 are as in the case of FIG. 1. That is, the wave plates 6-1 and 6-2 are configured to have an optical thickness that causes the total phase difference that occurs in the two wave plates 6-1 and 6-2 to be equivalent to the phase difference when a light is transmitted once through a plate included in the beam splitter 1A or 1B.

In contrast, because of their thickness, the wave plates 6-13 and 6-14 at the predetermined temperature, prior to the temperature control in the first embodiment, add the amount of delay for shifting the phase by 90 degrees to the amount of delay to be added to a reference light. Specifically, at the foregoing predetermined temperature, the wave plates 6-13 and 6-14 are configured to have an optical thickness that causes the total phase difference that occurs in the two wave plates 6-13 and 6-14 to be equivalent to the phase difference when a light is transmitted three times through a plate included in the beam splitter 1A or 1B. Accordingly, the phase differences are made equal in all paths.

In the foregoing case, at the same predetermined temperature prior to temperature control, the optical thickness of the wave plates 6-13 and 6-14 is different from the optical thickness of the wave plates 6-1 and 6-2 described above. Alternatively, predetermined temperatures prior to temperature control of the wave plates 6-1 and 6-2 and the wave plates 6-13 and 6-14 may have an offset. In this way, the total phase difference that occurs in the two wave plates 6-13 and 6-14 is given the amount of delay for shifting the phase by 90 degrees.

Accordingly, of two local lights to be mixed with a signal light in the beam splitters 1A and 1B, only a local light to be mixed with a signal light in the beam splitter 1B is given a 90-degree phase shift.

Therefore, pairs of a signal light and a local light (S1 and L1, and S2 and L2), which are mixed lights obtained by mixing in the beam splitter 1A, can be first detection lights 11 and I2 of in-phase channel (I-ch). Pairs of a signal light and a local light (S3 and L3, and S4 and L4), which are mixed lights obtained by mixing in the beam splitter 1B, can be second detection lights Q1 and Q2 of quadrature-phase channel (Q-ch).

As in the first embodiment described above, the temperature controller 6a individually controls the temperatures of the wave plates 6-1, 6-2, 6-13, and 6-14. That is, the temperature controller 6a individually controls the phases of two polarization components of a signal light that are orthogonal to each other by individually controlling the temperatures of the wave plates 6-1 and 6-2. Also, the temperature controller 6a individually controls the phases of two polarization components of a local light that are orthogonal to each other by individually controlling the temperatures of the wave plates 6-13 and 6-14. Accordingly, the polarization dependence of a phase difference between a vertical polarization component of a signal light and a vertical polarization component of a reference light on an optical path can be suppressed, and the polarization dependence of a phase difference between a horizontal polarization component of a signal light and a horizontal polarization component of a reference light on an optical path can be suppressed.

[A2] Second Modification of First Embodiment

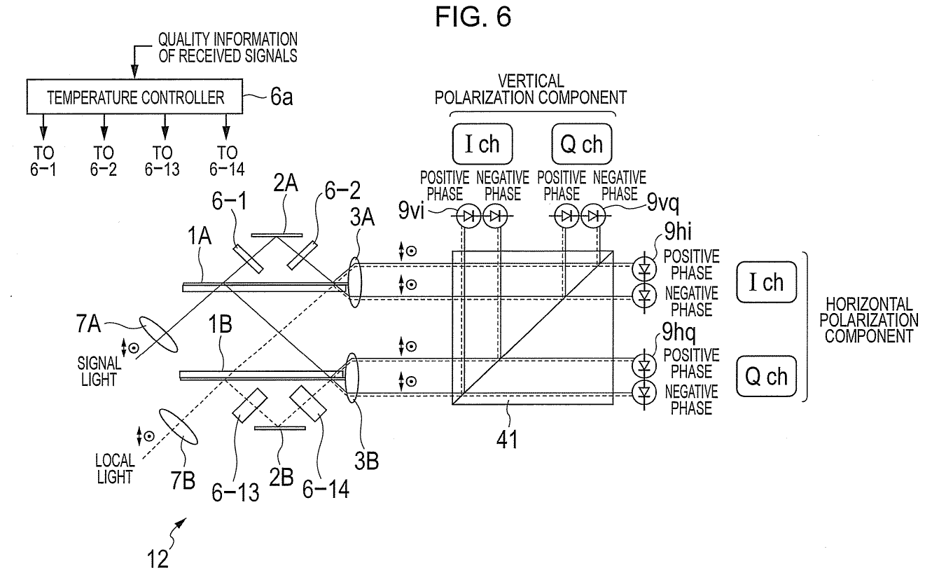

FIG. 6 is a diagram illustrating a second modification of the first embodiment. The second modification illustrated in FIG. 6 includes a 90-degree hybrid 12 that is different from the 90-degree hybrid 10 in FIG. 1 and the 90-degree hybrid 11 in FIG. 6, and the balanced receivers 9, which are the same as those in the first embodiment. In FIG. 6, the same reference numerals represent substantially the same portions as those in FIG. 1.

The 90-degree hybrid 12 illustrated in FIG. 6 includes a polarization splitter 41 that is different from the birefringent plate or polarization splitter 4 illustrated in FIGS. 1 and 5. The polarization splitter 41 is a birefringent plate that separates each of the detection lights I1, I2, Q1, and Q2 into a vertical polarization component and a horizontal polarization component and outputs the vertical polarization component and the horizontal polarization component. The polarization splitter 41 outputs the vertically polarized component and the horizontal polarization component, which are obtained by separating the polarizations, in different directions.

That is, the polarization splitter 4 illustrated in FIGS. 1 and 5 outputs the vertical polarization component and the horizontal polarization component, which are obtained by separating the polarizations, with optical axes that are parallel to each other. However, the polarization splitter 41 illustrated in FIG. 6 outputs the vertical polarization component and the horizontally polarization component in directions that are orthogonal to each other.

Therefore, the balanced receivers 9vi and 9vq for receiving vertical polarization components of detection lights and the balanced receivers 9hi and 9hq for receiving horizontal polarization components of detection lights are respectively arranged so as to face different faces of the polarization splitter 41.

As in the first embodiment described above, the temperature controller 6a individually controls the temperatures of the wave plates 6-1, 6-2, 6-13, and 6-14. Accordingly, as in the case illustrated in FIG. 1, the polarization dependence of a phase difference between a vertical polarization component of a signal light and a vertically polarization component of a reference light on an optical path can be suppressed, and the polarization dependence of a phase difference between a horizontal polarization component of a signal light and a horizontal polarization component of a reference light on an optical path can be suppressed.

### [B] Second Embodiment

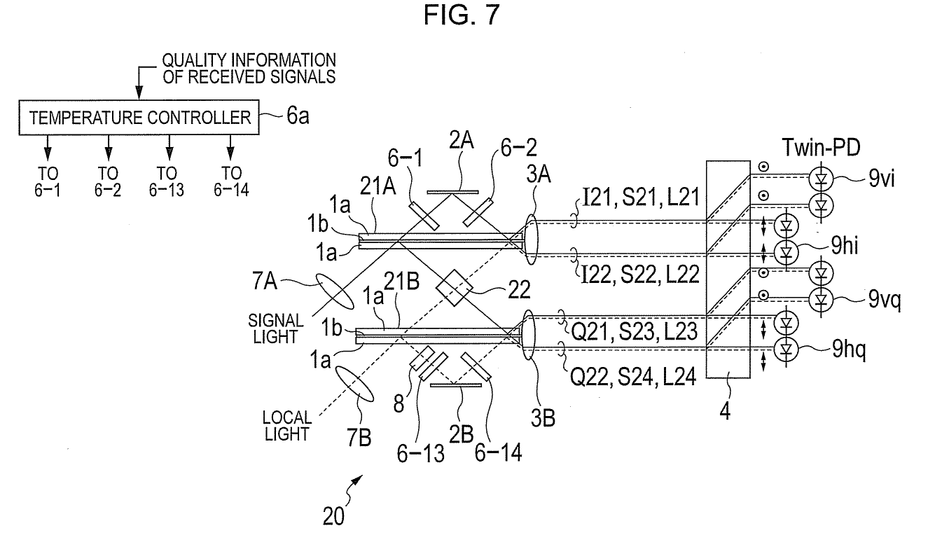

FIG. 7 is a diagram illustrating a second embodiment. In FIG. 7, a 90-degree hybrid 20 and balanced receivers 9vi, 9vq, 9hi, and 9hq are illustrated. The 90-degree hybrid 20 and the balanced receivers 9 may be integrated into a single optical module (optical front-end).

The 90-degree hybrid 20 illustrated in FIG. 7 includes beam splitters 21A and 21B that are different from the beam splitters 1A and 1B illustrated in FIG. 1 described above, and an optical path length difference correcting unit 22. The other structure of the 90-degree hybrid 20 is basically the same as that illustrated in FIG. 1. In FIG. 7, the same reference numerals represent substantially the same portions as those in FIG. 1.

That is, pairs of a signal light and a local light (S21 and L21, and S22 and L22), which are mixed lights obtained by mixing in the beam splitter 21A, can be first detection lights I21 and I22 of in-phase channel (I-ch). Pairs of a signal light and a local light (S23 and L23, and S24 and L24), which are mixed lights obtained by mixing in the beam splitter 21B, can be second detection lights Q21 and Q22 of quadrature-phase channel (Q-ch).

Compared with the beam splitters 1A and 1B illustrated in FIG. 1, the beam splitters 21A and 21B are the same as the beam splitters 1A and 1B in that the base members is are arranged in plane-parallel so as to face each other, but the beam splitters 21A and 21B are different from the beam splitters 1A and 1B in that the base members 1a are formed on two sides of the beam splitter films 1b.

The optical path length difference correcting unit 22 corrects the optical path length of a signal light that is split by the beam splitter 21A and that enters the beam splitter 21B, and corrects the optical path length of a reference light that is split by the beam splitter 21B and that enters the beam splitter 21A. In other words, the optical path length difference correcting unit 22 can be shared for correcting the optical path length of a signal light and the optical path length of a reference light.

The amounts of delay of a signal light S2i and a reference light L2i are expressed using expressions. The amounts of delay due to the base members 1a on the outer side of the beam splitters 21A and 21B and the optical path length difference correcting unit 22 are added to those in the first embodiment. Thus, expressions (S-2i) and (L-2i) are derived in which ys denotes the amount of delay of a signal light when the signal light passes through the optical path length difference correcting unit 22, and yl denotes the amount of delay of a reference light when the reference light passes through the optical path length difference correcting unit 22. From these expressions (S-2i) and (L-2i), the difference between the amount of delay of the signal light S2i and the amount of delay of the reference light L2i which are grouped in a pair is obtained using expression (D-2i).

x+bt+lm12+br+3x (S-21)

bt+x+x+bt+2x+yl (L-21)

lm12−x+br−bt+x−yl (D-21)

x+bt+lm12+bt+x+2x (S-22)

bt+x+x+br(+i)+x+x+yl (L-22)

lm12−x+bt−br−π+x−yl (D-22)

x+br(+π)+x+x+br(+π)+x+ys (S-23)

br+lm34+bt+x+3x (L-23)

3x−lm34+br−bt+3x (D-23)

x+br(+π)+x+x+bt+ys+x (S-24)

br+lm34+br+4x (L-24)

3x−lm34+bt−br+π+ys−3x (D-24)

Since 1m12=x and lm34=3x, the optical path length difference correcting unit 22 gives, to the reference light, delay so that an amount corresponding to the optical path length yl=−x will be corrected, and the optical path length difference correcting unit 22 gives, to the signal light, delay so that an amount corresponding to the optical path length ys=−3x will be corrected. Accordingly, the phase differences between the signal light and the reference light can be made equal in all paths.

As in the first embodiment described above, the temperature controller 6a individually controls the temperatures of the wave plates 6-1, 6-2, 6-13, and 6-14. Accordingly, as in the case illustrated in FIG. 1, the polarization dependence of a phase difference between a vertical polarization component of a signal light and a vertical polarization component of a reference light on an optical path can be suppressed, and the polarization dependence of a phase difference between a horizontal polarization component of a signal light and a horizontal polarization component of a reference light on an optical path can be suppressed.

Also in the second embodiment, the 90-degree hybrid 20 can be achieved in which, even when detection is performed at a stage prior to separation of a light into optical signals in individual polarization directions, a signal light and a reference light can be under optimal phase conditions in increments of a polarization component, and the polarization dependence of phase delay is suppressed. Therefore, the 90-degree hybrid 20 can be commonly used in coherent optical reception of two polarization components of a polarization-multiplexed signal. Since no interaction occurs between different polarizations, even if a polarization-multiplexed signal light enters the 90-degree hybrid 20, the result will be the same as the case where each polarization independently passes through the 90-degree hybrid 20.

### [C] Third Embodiment

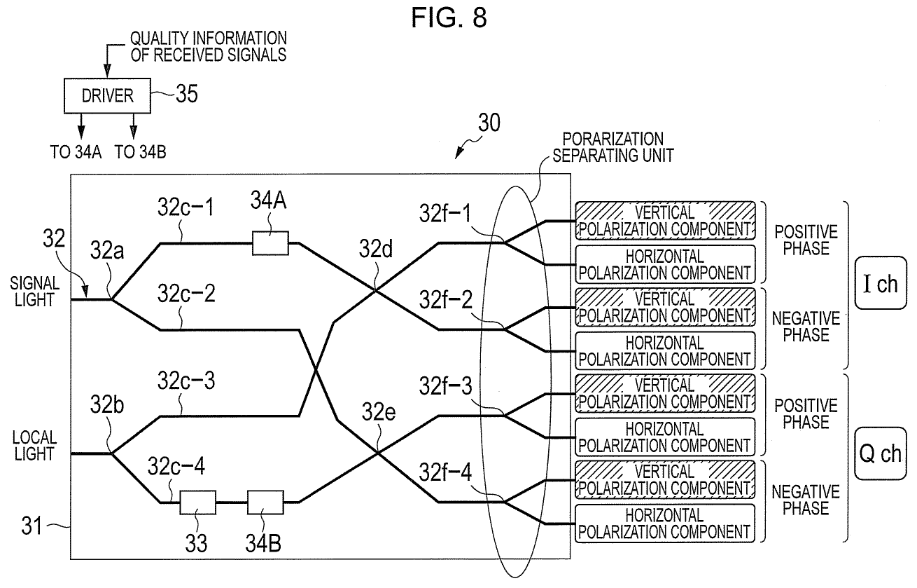

FIG. 8 is a diagram illustrating a third embodiment. In FIG. 8, a 90-degree hybrid 30 serving as an optical waveguide device is illustrated. The 90-degree hybrid 30 illustrated in FIG. 8 includes an optical waveguide 32, a 90-degree-phase shifter 33, and polarization phase controllers 34A and 34B, which are formed on a substrate 31.

The optical waveguide 32 includes a signal light splitter 32a, a reference light splitter 32b, splitting-waveguide sections 32c-1 to 32c-4, a first coupler 32d, a second coupler 32e, and polarization splitters 32f-1 to 32f-4. The signal light splitter 32a splits an input signal light into a first signal light and a second signal light. The reference light splitter 32b splits an input reference light into a first reference light and a second reference light.

The splitting-waveguide section 32c-1 directs the first signal light from the signal light splitter 32a to the first coupler 32d. The splitting-waveguide section 32c-2 directs the second signal light from the signal light splitter 32a to the second coupler 32e. Furthermore, the splitting-waveguide section 32c-3 directs the first reference light from the reference light splitter 32b to the first coupler 32d. The splitting-waveguide section 32c-4 directs the second reference light from the reference light splitter 32b to the second coupler 32e.

In the splitting-waveguide section 32c-1 described above, the polarization phase controller 34A, which corresponds to the wave plates 6-1 and 6-2 in the first and second embodiments described above, is provided. That is, the polarization phase controller 34A is a first polarization phase controller that is provided on an optical path between the signal light splitter 32a and the first coupler 32d and that individually controls the phases of two orthogonal polarization components of the first signal light and outputs the phase-controlled polarization components.

In the splitting-waveguide section 32c-4, the 90-degree-phase shifter 33, which corresponds to the 90-degree-phase shifter 5 in FIG. 1 descried above, and the polarization phase controller 34B, which corresponds to the wave plates 6-3 and 6-4 in FIG. 1 described above, are provided. That is, the splitting-waveguide section 32c-4 is a second polarization phase controller that is provided on an optical path between the reference light splitter 32b and the second coupler 32e and that individually controls the phases of two orthogonal polarization components of the reference signal light and outputs the phase-controlled polarization components.

The 90-degree-phase shifter 33 and the polarization phase controllers 34A and 34B described above can perform phase control by applying, for example, voltages through electrodes to the corresponding splitting-waveguide sections 32c-1 and 32c-4.

In this case, as illustrated in FIG. 8, a driver 35 can be provided, which drives and controls the polarization phase controllers 34A and 34B so that the quality of received signals becomes favorable on the basis of quality information of received signals from the electrical signal processor 133 (see FIG. 2). That is, the driver 35 applies, on the basis of the quality information from the electrical signal processor 133, voltages for controlling the phases of the individual polarization components to the polarization phase controllers 34A and 34B. Accordingly, the driver 35 can control the polarization phase controllers 34A and 34B so that the quality of received signals becomes favorable by increasing or reducing the voltages to be applied.

In this case, the polarization phase controllers 34A and 34B can be realized by splitting a light into orthogonal polarization components by using a waveguide structure such as a Mach-Zehnder interferometer, and individually controlling the phases of the polarization components through the application of voltages. Also, the 90-degree-phase shifter 33 and the polarization phase controller 34B may be integrated to perform phase control.

In this way, as in the first and second embodiments described above, first and second detection lights can be outputted using the first signal light and the second reference light which have been phase-controlled at each polarization component.

That is, the first coupler 32d causes the first signal light (which has been phase-controlled at each polarization component) and the first reference light to interfere with each other and outputs a first detection light. The second coupler 32e causes the second signal light and the second reference light (whose phase is shifted by 90 degrees and which has been phase-controlled at each polarization component) to interfere with each other and outputs a second detection light.

For example, two-input two-output optical couplers can be used as the first coupler 32d and the second coupler 32e. Specifically, an optical coupler serving as the first coupler 32d can output two outputs with opposite phases (positive phase and negative phase) from a mixed light obtained from two inputs of the first signal light obtained by splitting performed by the signal light splitter 32a and the first reference light obtained by splitting performed by the reference light splitter 32b. Similarly, an optical coupler serving as the second coupler 32e can output two outputs with opposite phases (positive phase and negative phase) from a mixed light obtained from two inputs of the second signal light obtained by splitting performed by the signal light splitter 32a and the second reference light obtained by splitting performed by the reference light splitter 32b.

The polarization splitter 32f-1 can split one of two outputs of detection lights obtained by the first coupler 32d into two orthogonal polarization components, that is, a vertical polarization component and a horizontal polarization component. Similarly, the polarization splitter 32f-2 can split the other one of two outputs of detection lights obtained by the first coupler 32d into a vertical polarization component and a horizontal polarization component.

Furthermore, the polarization splitter 32f-3 can split one of two outputs of detection lights outputted by the second coupler 32e into two orthogonal polarization components, that is, a vertical polarization component and a horizontal polarization component. Similarly, the polarization splitter 32f-4 can split the other one of two outputs of detection lights outputted by the second coupler 32e into a vertical polarization component and a horizontal polarization component.

The vertical polarization components obtained by splitting performed by the polarization splitters 32f-1 and 32f-2 can be received by the balanced receiver 9vi, as in the case illustrated in FIG. 1 described above. Also, the horizontal polarization components obtained by splitting performed by the polarization splitters 32f-1 and 32f-2 can be received by the balanced receiver 9hi.

Furthermore, the vertical polarization components obtained by splitting performed by the polarization splitters 32f-3 and 32f-4 can be received by the balanced receiver 9vq, as in the case illustrated in FIG. 1 described above. Also, the horizontal polarization components obtained by splitting performed by the polarization splitters 32f-3 and 32f-4 can be received by the balanced receiver 9hq.

Also in the third embodiment, the 90-degree hybrid 30 can be achieved in which, even when detection is performed at a stage prior to separation of a light into optical signals in individual polarization directions, a signal light and a reference light can be under optimal phase conditions at each polarization component, and the polarization dependence of phase delay is suppressed. Therefore, the 90-degree hybrid 30 can be commonly used in coherent optical reception of two polarization components of a polarization-multiplexed signal. Since no interaction occurs between different polarizations, even if a polarization-multiplexed signal light enters the 90-degree hybrid 30, the result will be the same as the case where each polarization independently passes through the 90-degree hybrid 30.

### [D] Others

Various modifications can be made without departing from the scope of the disclosed application, regardless of the above-described embodiments. For example, although the birefringent plate is used as the polarization splitter 4, other optical devices may be employed as the polarization splitter 4. According to the disclosure described above, devices as set forth in the claims can be manufactured.

According to the disclosed techniques, a 90-degree hybrid can be achieved in which, even when detection is performed at a stage prior to separation of a light into optical signals in individual polarization directions, a signal light and a reference light can be under optimal phase conditions at each polarization component, and the polarization dependence of phase delay is suppressed. Therefore, the 90-degree hybrid can be commonly used in coherent optical reception of two polarization components of a polarization-multiplexed signal. Since no interaction occurs between different polarizations, even if a polarization-multiplexed signal light enters the 90-degree hybrid, the result will be the same as the case where each polarization independently passes through the 90-degree hybrid.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

A coupler in the above embodiments may comprise an optical coupler including a half mirror.

What is claimed is:

1. A interferometer for receiving a signal light and a reference light and for outputting phase detection signal lights, comprising:
a first beam splitter for splitting one of the signal and the reference lights into a first and a second branch lights;
a second beam splitter for splitting the other of the signal and the reference lights into a third and a fourth branch lights;
a first coupler for causing the first and the third branch lights to interfere with each other, and outputting a first phase detection signal light;
a second coupler for causing the second and the fourth branch light to interfere with each other, and outputting a second phase detection signal light;
an optical phase shifter for shifting the optical phase by an amount between the third and the fourth branch lights inputted into the first or second coupler;
a first polarization phase controller provided between the first beam splitter and the first coupler, the first polarization phase controller individually controlling phases of two orthogonal polarization components of the first branch light and outputting the phase-controlled polarization components of the first branch light; and
a second polarization phase controller provided between the second beam splitter and the second coupler, the second polarization phase controller individually controlling phases of two orthogonal polarization components of the fourth branch light and outputting the phase-controlled polarization components of the fourth branch light.

2. The interferometer according to claim 1, further comprising a polarization splitter for splitting each of the first and the second phase detection signal lights into different polarizations orthogonal to each other.

3. The interferometer according to claim 1, wherein the first and the second interferometer is a half mirror or an optical coupler.

4. The interferometer according to claim 1, wherein the optical phase shifter shifts the optical phase by 90 degrees between the third and the fourth branch lights inputted into the first or second coupler.

5. The interferometer according to claim 1, further comprising a plurality of reflectors provided between the first beam splitter and the first coupler, and provided between the second beam splitter and the second coupler.

6. The interferometer according to claim 2, wherein the first polarization phase controller includes:
a first wave plates disposed in tandem on the first optical path, the first and the second wave plates each having a fast axis and a slow axis vertical with respect to the fast axis, the fast axis of the first wave plate being vertical with respect to the fast axis of the second wave plate; and
a first temperature controller for controlling each temperature of the first and the second wave plates,
wherein the second polarization phase controller includes:
a third and a fourth wave plates disposed in tandem on the second optical path, the third and the fourth wave plates each having a fast axis and a slow axis vertical with respect to the fast axis, the fast axis of the third wave plate being vertical with respect to the fast axis of the fourth wave plate; and
a second temperature controller controlling each temperature of the first, the second, the third and the fourth wave plates.

7. The interferometer according to claim 2, wherein the reference light is a linearly-polarized light whose polarization directions are tilted by 45 degrees with respect to the polarization directions of the different polarizations split by the polarization splitter.

8. The interferometer according to claim 1, wherein the second polarization phase controller and the optical phase shifter integrally being provided between the second beam splitter and the second coupler.

9. The interferometer according to claim 1, further comprising at least a collimator for collimating the first phase detection signal light outputted by the first coupler and the second phase detection signal light outputted by the second coupler.

10. The interferometer according to claim 1, wherein the first beam splitter and the one of the first and the second couplers are composed of a first half mirror integrally provided, and the second beam splitter and the other of the first and the second couplers are composed of a second half mirror integrally provided.

11. An optical module comprising:
a first beam splitter for splitting one of a signal and a reference lights into a first and a second branch lights;
a second beam splitter for splitting the other of the signal and the reference lights into a third and a fourth branch lights;
a first coupler for causing the first and the third branch lights to interfere with each other, and outputting a first phase detection signal light;
a second coupler for causing the second and the fourth branch light to interfere with each other, and outputting a second phase detection signal light;
an optical phase shifter for shifting the optical phase by an amount between the third and the fourth branch lights inputted into the first or second coupler;
a first polarization phase controller provided between the first beam splitter and the first coupler, the first polarization phase controller individually controlling phases of two orthogonal polarization components of the first branch light and outputting the phase-controlled polarization components of the first branch light;
a second polarization phase controller provided between the second beam splitter and the second coupler, the second polarization phase controller individually controlling phases of two orthogonal polarization components of the fourth branch light and outputting the phase-controlled polarization components of the fourth branch light;
a polarization splitter for splitting each of the first and the second phased detection signal lights from the first and second couplers into different polarizations orthogonal to each other; and
a plurality of light receivers provided at a stage subsequent to the polarization splitter, for receiving each of the different polarizations of the each of the first and the second detection lights.

12. A optical receiver comprising a polarization interferometer for receiving a signal light and a reference light and for outputting phase detection signal lights, the polarization coupler including:
a first beam splitter for splitting one of the signal and the reference lights into a first and a second branch lights;
a second beam splitter for splitting the other of the signal and the reference lights into a third and a fourth branch lights;
a first coupler for causing the first and the third branch lights to interfere with each other, and outputting a first phase detection signal light;
a second coupler for causing the second and the fourth branch light to interfere with each other, and outputting a second phase detection signal light;
an optical phase shifter for shifting the optical phase by an amount between the third and the fourth branch lights inputted into the first or second coupler;
a first polarization phase controller provided between the first beam splitter and the first coupler, the first polarization phase controller individually controlling phases of two orthogonal polarization components of the first branch light and outputting the phase-controlled polarization components of the first branch light; and
a second polarization phase controller provided between the second beam splitter and the second coupler, the second polarization phase controller individually controlling phases of two orthogonal polarization components of the fourth branch light and outputting the phase-controlled polarization components of the fourth branch light.
